(19) United States
(12) Patent Application Publication
(10) Pub. No.: US 2017/0249822 A1
(43) Pub. Date: Aug. 31, 2017

(54) APPARATUS CONFIGURED TO ISSUE WARNING TO WEARER OF DISPLAY, AND METHOD THEREFOR

(71) Applicant: CANON KABUSHIKI KAISHA, Tokyo (JP)

(72) Inventors: Takuya Kotoyori, Kawasaki-shi (JP); Takashi Shiozawa, Utsunomiya-shi (JP)

(21) Appl. No.: 15/442,352

(22) Filed: Feb. 24, 2017

(30) Foreign Application Priority Data
Feb. 29, 2016 (JP) 2016-038041

(51) Int. Cl. G08B 21/04

(52) U.S. Cl. CPC G08B 21/0446

(57) ABSTRACT

An information processing apparatus includes a position acquisition unit configured to acquire a position of a display device in use by a user, a region estimation unit configured to estimate a region where the user exists, based on the position of the display device, an input unit configured to input a position of an object, a calculation unit configured to calculate a distance between the position of the object and the region, and a warning unit configured to issue a warning to the user based on the distance.

### BACKGROUND OF THE INVENTION

Field of the Invention

The aspect of the embodiments relates to a technique for issuing a warning to a wearer of a display.

Description of the Related Art

There are known the mixed reality (MR) technique and the augmented reality (AR) technique as techniques for integrating a real world and a virtual world in real time. These techniques are for seamlessly integrating a real space and a virtual space created by a computer. They are expected to be applied to various fields, such as an assembly assist that displays a work procedure and how a wiring is laid while superimposing one on the other at the time of assembly work, and a surgery assist that displays a condition inside a patient's body on a surface of the patient's body in a superimposing manner.

One of available apparatuses for allowing an observer to feel as if a virtual object actually exists in the real space is a video see-through information processing apparatus. Hereinafter, the video see-through information processing apparatus will be referred to as a mixed reality apparatus. This is an apparatus that images the real world by a video camera, and causes a display unit, such as a display, to display a combined image formed by superimposing the virtual object on this real-world image in real time, thereby presenting the combined image to the observer. Examples of an apparatus generally used as such an information processing apparatus include a portable information terminal called a tablet terminal that includes the video camera on a back side thereof, and a video see-through head-mounted display (HMD) configured to be mounted on a head portion.

Further, according to the video see-through, for the presentation of the mixed reality, there is the display of the display device in a field of view of the user of the mixed reality apparatus, and a region where computer graphics (CG) is drawn is also contained in the display of the display device. Therefore, the user of the mixed reality apparatus can observe an image appearing as if the virtual object exists in the real world. However, compared to a range of view in the real world that would be an original field of view of the user of the mixed reality, a region hiding the real world exists according to the display device and the drawn CG. The range of view of the user in the real world is therefore narrowed.

Especially, when a plurality of users experiencing the mixed reality tries the mixed reality at the same time, the CG may hide another user or an object in the real world, so that a risk of a collision may increase and/or an effect of the mixed reality may be impaired due to proximity of the user. Under such a situation, the user of the mixed reality apparatus is not equipped with a measure for detecting the situation under which the user is located in proximity to another user or an object, and, for an operator providing the mixed reality with use of the mixed reality apparatus, a measure is prepared for accurately recognizing the proximity situation among the plurality of users.

Japanese Patent No. 4642538 discusses that a distance between HMD users is calculated from positions of head portions of the HMD wearers, and proximity between the users is reported when the distance reduces to a predetermined value or shorter. Further, U.S. Pat. No. 5,900,849 discusses that a warning is issued when a position of the HMD moves out of a predetermined region, and a display thereof is switched to a real-world video image.

In Japanese Patent No. 4642538, a distance between the HMDs is calculated, and the proximity between the users is reported when the distance reduces to the predetermined value or shorter. According to this method, when both of the users are in an upright state, the distance between the HMDs is approximately equal to the distance between the HMD wearers, whereby the risk of the collision can be correctly evaluated. Further, when the HMD wearers are slowly moving, the HMD wearers can stop immediately anytime, whereby the possibility of the collision between the HMD wearers can be correctly evaluated. However, the following situations lie in this method. When one of the HMD wearers squats down while the other of the HMD wearers stands up, the distance between the HMDs is undesirably measured to be a longer distance than the distance between the HMD wearers, whereby the risk of the collision is inappropriately underestimated. Further, when being moving their hands or heads, or being standing up, the HMD wearers may be unable to stop in the middle of the motions. Therefore, even when the HMDs are located a certain distance away from each other, the HMD wearers may end up colliding with each other and the risk of the collision is inappropriately underestimated.

Further, in the method that issues the warning when the position of the HMD moves out of the predetermined region, like U.S. Pat. No. 5,900,849, it is possible to correctly evaluate a risk of a collision with a wall surrounding the experience region, a step at a foot, and the like, the method has an issue of its incapability of determining a risk of a collision with an obstacle existing in an experience region.

### SUMMARY OF THE INVENTION

According to an aspect of the embodiments, an information processing apparatus includes a position acquisition unit configured to acquire a position of a display device in use by a user, a region estimation unit configured to estimate a region where the user exists, based on the position of the display device, an input unit configured to input a position of an object, a calculation unit configured to calculate a distance between the position of the object and the region, and a warning unit configured to issue a warning to the user based on the distance.

Further features of the disclosure will become apparent from the following description of exemplary embodiments with reference to the attached drawings.

### BRIEF DESCRIPTION OF THE DRAWINGS

FIG. 1 is a block diagram illustrating a functional configuration of an information processing apparatus according to a first exemplary embodiment.

FIG. 2 is a block diagram illustrating a functional configuration of an information processing apparatus according to a first modification of the first exemplary embodiment.

FIG. 3 is a block diagram illustrating a functional configuration of an information processing apparatus according to a second modification of the first exemplary embodiment.

FIG. 4 is a block diagram illustrating a functional configuration of an information processing apparatus according to a third modification of the first exemplary embodiment.

FIG. 5 is a block diagram illustrating a functional configuration of an information processing apparatus according to a fourth modification of the first exemplary embodiment.

FIG. 6 illustrates an example of a hardware configuration according to the first exemplary embodiment.

FIG. 7 is a flowchart illustrating a flow of processing performed by the information processing apparatus according to the first exemplary embodiment.

FIG. 8 is a block diagram illustrating a functional configuration of an information processing apparatus according to a second exemplary embodiment.

FIG. 9 is a block diagram illustrating a functional configuration of an information processing apparatus according to a first modification of the second exemplary embodiment.

FIG. 10 is a block diagram illustrating a functional configuration of an information processing apparatus according to a second modification of the second exemplary embodiment.

FIG. 11 is a flowchart illustrating a flow of processing performed by the information processing apparatus according to the second exemplary embodiment.

FIG. 12 is a diagram illustrating an estimation of a region according to the first modification of the first exemplary embodiment.

FIG. 13 is a diagram illustrating an estimation of a human posture according to the second modification of the first exemplary embodiment.

### DESCRIPTION OF THE EMBODIMENTS

In the following description, typical exemplary embodiments of the disclosure will be described with reference to the attached drawings. In the present exemplary embodiments, when a user observes computer graphics (CG) while wearing a head-mounted display (herein after referred to as an HMD), a region of the HMD wearer is estimated from a position of the HMD. A distance to a virtual object is calculated based on the estimated region and a warning is displayed according to the calculated distance.

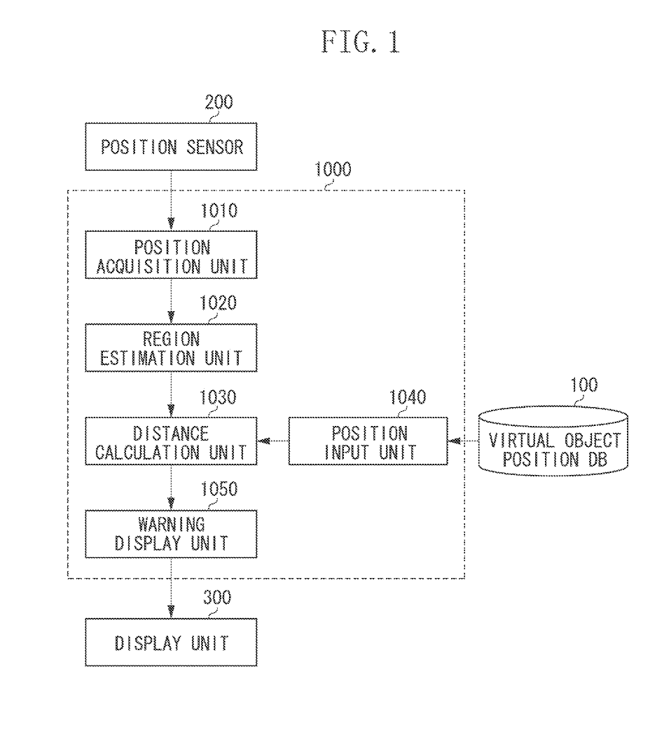

An information processing apparatus according to a first exemplary embodiment uses the position of the HMD in a method for estimating the region of the HMD wearer. FIG. 1 is a block diagram illustrating a functional configuration of the information processing apparatus according to the present exemplary embodiment. A system according to the present exemplary embodiment includes a virtual object position database (DB) 100, a position sensor 200 mounted at a display unit 300, the display unit 300, and an information processing apparatus 1000. Then, the virtual object position DB 100 holds a position of the virtual object in a three-dimensional space. The position sensor 200 mounted at the display unit 300 outputs a value measured by the position sensor 200 as a position of the display unit 300. Now, a relative positional relationship between the position sensor 200 and the display unit 300 is calibrated in advance, and the value output from the position sensor 200 is treated as the position of the display unit 300. The position sensor 200 may be a sensor employing any known method, such as an optical sensor and a magnetic sensor.

In the present disclosure, a position and a posture refer to a combination of three parameters indicating a position in a reference coordinate system in which three axes orthogonal to one another with an origin set to one point in an environment are defined as an X axis, a Y axis, and a Z axis, respectively, and three parameters indicating a posture (an orientation) thereof. Further, the position of the virtual object and the position of the display unit 300 are positions in the same coordinate system. Then, the origin of the reference coordinate system is set to a point on a floor surface where the HMD wearer moves.

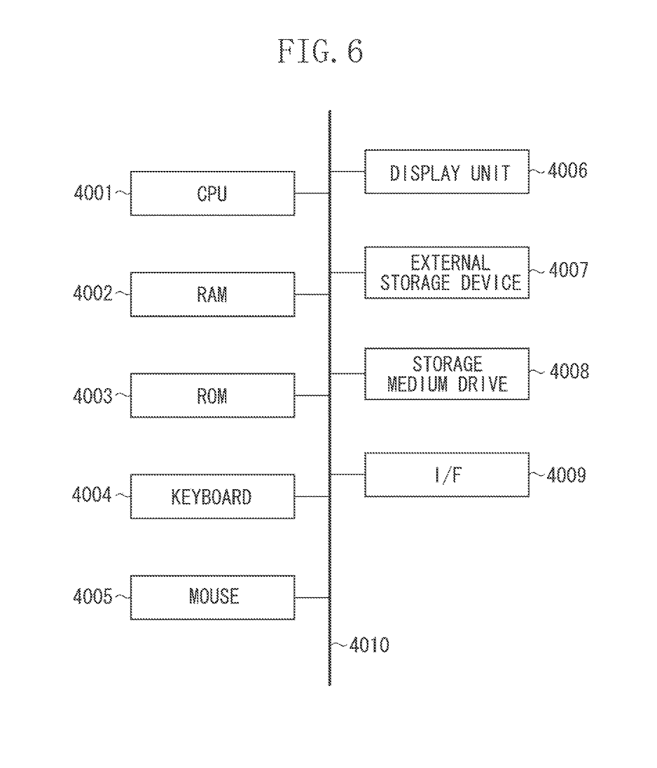

FIG. 6 illustrates a hardware configuration of the information processing apparatus 1000 according to the present exemplary embodiment. In FIG. 6, a central processing unit (CPU) 4001 comprehensively controls each device connected via a bus 4010. The CPU 4001 reads out and executes a processing step and a program stored in a read only memory (ROM) 4003. Each processing program regarding the present exemplary embodiment, a device driver, and the like, including an operating system (OS), are stored in the ROM 4003, and are temporarily stored in a random access memory (RAM) 4002 to be executed by the CPU 4001 as appropriate. Further, an interface (I/F) 4009 inputs data from an external device (a display device, an operation device, and the like) as an input signal in a format that the information processing apparatus 1000 can process. Further, the I/F 4009 outputs data to the external device (the display device) as an output signal in a format that the display device can process.

The information processing apparatus 1000 illustrated in FIG. 1 includes a position acquisition unit 1010 for acquiring a position of the display unit 300, a region estimation unit 1020, a distance calculation unit 1030, a position input unit 1040, and a warning display unit 1050. The information processing apparatus 1000 further includes the virtual object position DB 100, the position sensor 200, and the display unit 300. The position sensor 200 is mounted at the display unit 300.

The position acquisition unit 1010 continuously acquires the position indicated by the position sensor 200 mounted at the display unit 300. The acquired position of the display unit 300 is input to the region estimation unit 1020.

The region estimation unit 1020 estimates a region where the display unit wearer (the HMD wearer) exists (hereinafter also referred to as simply a region of the display unit wearer) based on the position of the display unit 300 that is acquired by the position acquisition unit 1010. In the present exemplary embodiment, the region estimation unit 1020 calculates coordinates of a center of a head portion based on the position of the display unit 300, and calculates a cylindrical region centered at the center of the head portion. The method for estimating the region of the display unit wearer will be described below. The calculated region of the display unit wearer is input to the distance calculation unit 1030.

The position input unit 1040 acquires the position of the virtual object from the virtual object position DB 100. The acquired position of the virtual object is input to the distance calculation unit 1030. The position stored in the virtual object position DB 100 at this time may be manually input data or may be automatically measured data.

The distance calculation unit 1030 calculates a distance between the input region of the display unit wearer and the virtual object. The calculated distance is input to the warning display unit 1050.

The warning display unit 1050 displays, on the display unit 300, warning information notifying the display unit wearer of a risk of a collision according to the input distance. The information processing apparatus 1000 may be configured to issue the warning with use of audio, such as a warning sound, instead of the display.

The CPU 4001 develops the program stored in the ROM 4003 into the RAM 4002 and performs processing according to each of flowcharts that will be described below, by which each of these functional units is realized. Further, for example, in a case where hardware is constructed as an alternative to the software processing using the CPU 4001, this configuration can be realized by preparing a calculation unit or a circuit configured to correspond to the processing of each of the functional units that will be described herein.

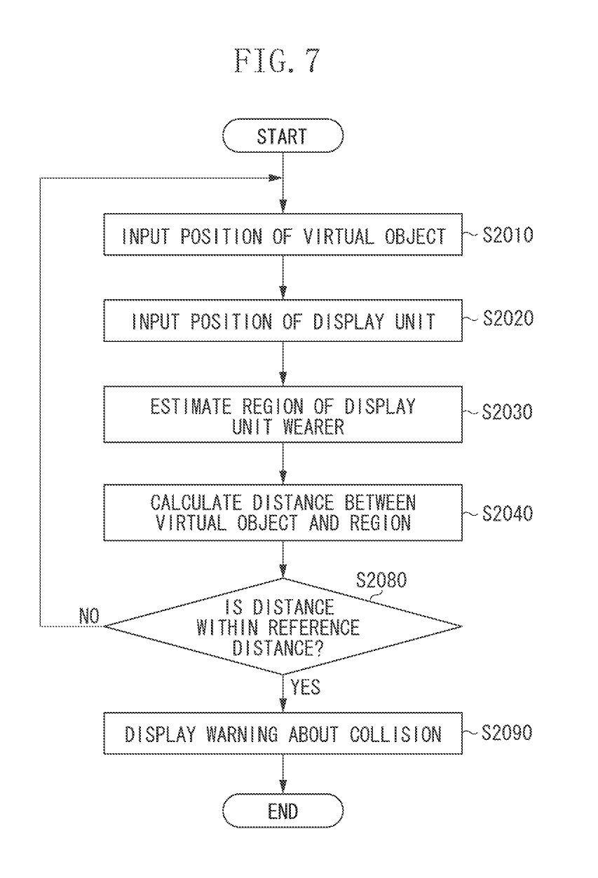

Next, a processing procedure performed by the information processing apparatus 1000 according to the first exemplary embodiment will be described. FIG. 7 is a flowchart illustrating the processing procedure performed by the information processing apparatus 1000 according to the first exemplary embodiment.

In step S2010, the position input unit 1040 acquires the position of the virtual object from the virtual object position DB 100.

In step S2020, the position acquisition unit 1010 acquires the position of the display unit 300 from the position sensor 200 mounted at the display unit 300. At this time, the position sensor 200 outputs the value measured by the position sensor 200 as the position of the display unit 300. Now, the relative positional relationship between the position sensor 200 and the display unit 300 is calibrated in advance, and the value output from the position sensor 200 is treated as the position of the display unit 300. The position sensor 200 may be a sensor employing any known method, such as an optical sensor and a magnetic sensor.

In step S2030, the region estimation unit 1020 estimates that the center of the head portion of the display unit wearer is located at a position displaced from the position of the display unit 300 backward by a predetermined position T1 and downward by a predetermined position T2. T1 and T2 can be determined from a shape of the display unit 300 which is worn. However, T1 and T2 are not limited thereto, as long as they are values set in consideration of a size of a human head and a size of the HMD. The region estimation unit 1020 creates a cylinder having a predetermined radius R1 while being centered at the center of the head portion that has been estimated by the region estimation unit 1020, and sets this cylinder as the region of the display unit wearer. In the present exemplary embodiment, the radius R1 is assumed to be 1 m. However, the radius R1 is not limited thereto, as long as this is a value determined based on a motion range where the display unit wearer cannot stop halfway, such as a range corresponding to a human volume, a range where a human can travel by taking only one step, and a range where a human can stretch out his/her hand.

In step S2040, the distance calculation unit 1030 acquires the distance between the input position of the virtual object and the estimated region of the display unit wearer. The distance between the virtual object and the estimated region of the display unit wearer at this time may be a minimum distance between the virtual object and the region or may be a length of a perpendicular line drawn from the position of the virtual object to a surface of the region. In the present example, the issue of the warning will be described referring to an example in which the warning is issued when the wearer of the HMD moves into proximity to the virtual object. However, when the wearer of the HMD moves into proximity to a real object, such as an actually existing obstacle and another HMD wearer, the warning can also be issued in a similar manner based on positions of these objects.

In step S2080, the warning display unit 1050 determines whether the input distance is within a reference distance. The reference distance at this time may be a value input by the user or may be a predetermined value.

In step S2090, the warning display unit 1050 displays on the display unit 300 the warning notifying the display unit wearer of the possibility of the collision. The display of the warning may be a display of a warning mark or may be a display of a warning sentence. Further, the display of the CG may be stopped and/or a notification with use of audio may be issued at the same time as the display of the warning.

The present exemplary embodiment allows the information processing apparatus 1000 to notify the display unit wearer of the risk of the collision with the obstacle based on the position of the display unit 300 even in a case where there is not prepared an apparatus for observing the display unit wearer from outside. The information processing apparatus 1000 can correctly estimate the distance between the HMD wearer and the virtual object even when the HMD wearer squats down, by estimating the region of the display unit wearer. Further, even while the HMD wearer is in the middle of a motion that cannot be stopped halfway, such as standing up, the information processing apparatus 1000 can warn the HMD wearer about an obstacle with which there is a possibility that the HMD wearer may collide because the range where the HMD wearer can travel with one motion is contained in the region of the HMD wearer.

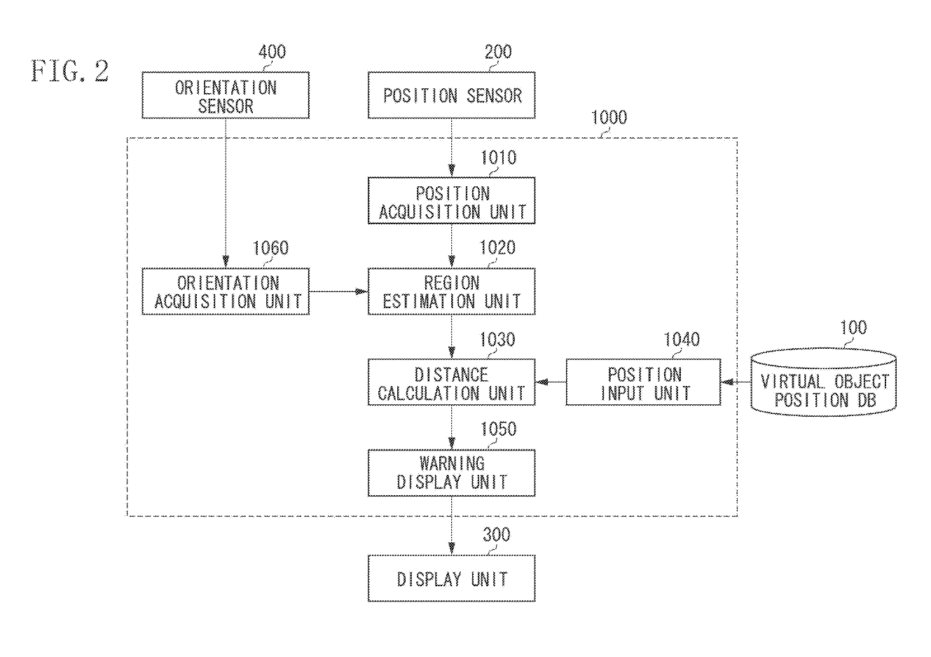

FIG. 2 is a block diagram illustrating a functional configuration of an information processing apparatus according to a first modification of the first exemplary embodiment. In the present modification, the system includes an orientation sensor 400 as a sensor for an orientation of the display unit 300, and the information processing apparatus 1000 includes an orientation acquisition unit 1060 for acquiring the orientation of the display unit 300, in addition to the first exemplary embodiment. The orientation sensor 400 mounted at the display unit 300 outputs a value measured by the orientation sensor 400 mounted at the display unit 300 as the orientation of the display unit 300. Now, a relative orientation relationship between the orientation sensor 400 and the display unit 300 is calibrated in advance, and the value output from the orientation sensor 400 is treated as the orientation of the display unit 300. The orientation sensor 400 may be a sensor employing any known method, such as an optical sensor, a magnetic sensor, and a sensor using a gyroscope.

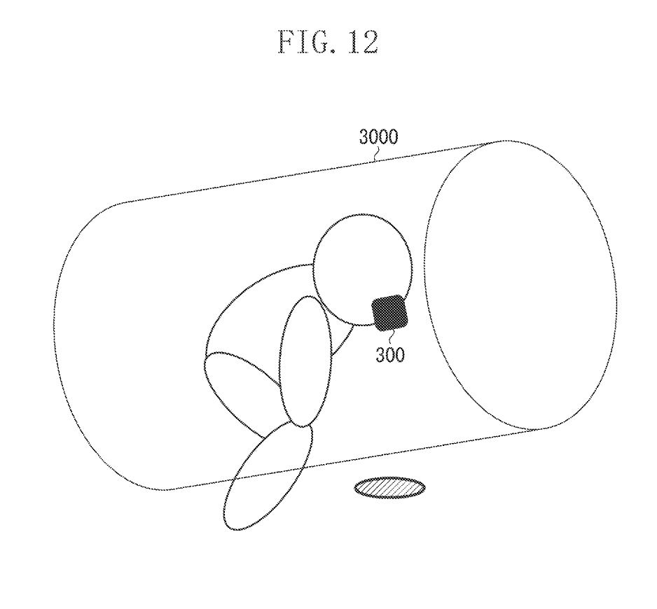

In the first exemplary embodiment, only the position of the display unit 300 is used for the estimation of the region of the wearer of the display unit 300. However, the orientation acquisition unit 1060 receives the input from the orientation sensor 400 mounted at the display unit 300, and inputs the received data to the region estimation unit 1020. In this case, the region estimation unit 1020 may create the cylinder having the predetermined radius R1 from the center of the head portion of the display unit wearer, and estimate a region defined by tilting the cylinder according to a posture of the display unit wearer. FIG. 12 illustrates a region 3000 tilted according to the orientation sensor 400 mounted at the display unit 300. The region 3000 is a region defined by rotating the estimated cylindrical region around the center of the head portion of the display unit wearer in such a manner that an axis of the cylinder is tilted by the same degree as the value output from the orientation sensor 400 mounted at the display unit 300. The present modification allows the information processing apparatus 1000 to warn the display unit wearer about the obstacle with which there is the possibility that the display unit wearer may collide even when the display unit wearer is observing the CG located at his/her foot, because a range where the display unit wearer can move his/her head portion while bending over is contained in the estimated region.

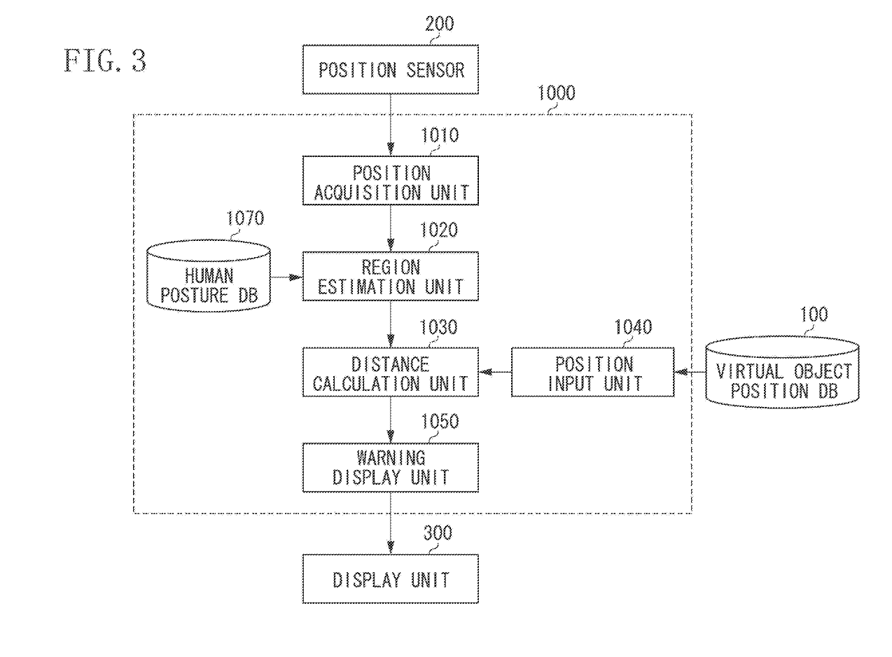

FIG. 3 is a block diagram illustrating a functional configuration of an information processing apparatus according to a second modification of the first exemplary embodiment. In the present modification, the information processing apparatus 1000 includes a human posture DB 1070 in addition to the first exemplary embodiment. The human posture DB 1070 is a database recording therein positions of the head portion, the torso, the arm, the foot, and the like when a human takes some posture in the three-dimensional space.

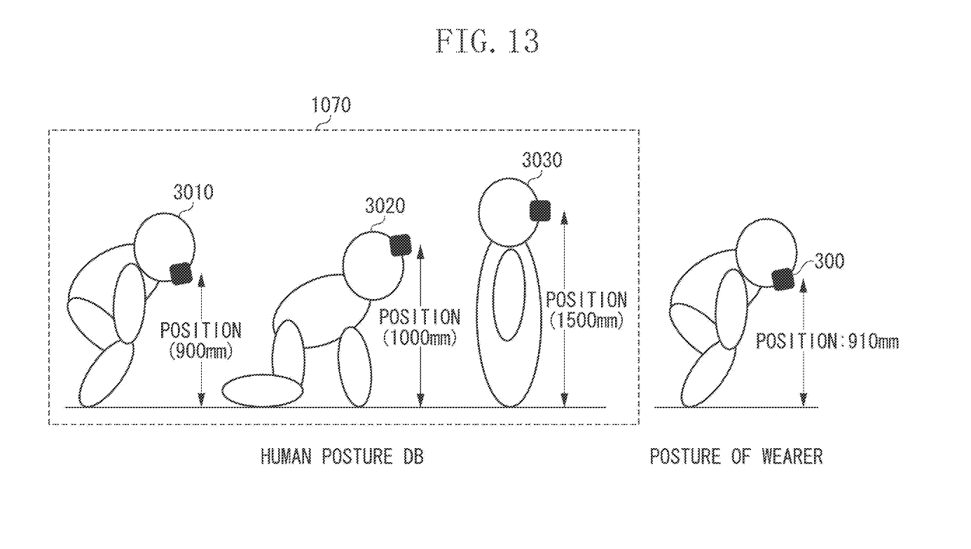

In the first exemplary embodiment, only the position of the display unit 300 is used for the estimation of the region of the display unit wearer. However, an input from the human posture DB 1070 may be input to the region estimation unit 1020, which estimates the region of the display unit wearer. In this case, the region estimation unit 1020, which estimates the region of the display unit wearer, acquires a posture most closely matching the position of the head portion of the display unit wearer, by referring to the human posture DB 1070 based on the center of the head portion of the display unit wearer. FIG. 13 illustrates a relationship between the human posture DB 1070 and the display unit 300. A posture 3010, a posture 3020, and a posture 3030 are data indicating the positions of the head portion, the torso, the arm, and the foot that are recorded in the human posture DB 1070.

The region estimation unit 1020 estimates a posture having such a position that the position of the display unit 300 from a reference surface set to the floor surface in the reference coordinate system is closest to the position of the head portion that is recorded in the human posture DB 1070, as the posture of the display unit wearer. For example, in FIG. 13, when the position of the display unit 300 is 910 mm due to the posture of the wearer, the region estimation unit 1020 estimates the posture 3010 which is closest one recorded in the human posture DB 1070 as the posture of the display unit wearer.

Further, any known method may be used as the method for acquiring the matching posture from the human posture DB 1070, as long as this method is a method that acquires the posture based on the position of the display unit wearer. The region estimation unit 1020 generates a bounding box enclosing the acquired posture, and sets this box as the region of the display unit wearer. The estimated bounding box may be a box enclosing the most closely matching posture, or may be a box enclosing all of matching postures.

The present exemplary embodiment prevents the information processing apparatus 1000 from estimating an excessively large region as the region of the display unit wearer regardless of what kind of posture the display unit wearer takes, thereby allowing the information processing apparatus 1000 to avoid undesirable oversensitive detection of the obstacle with which there is the possibility that the display unit wearer may collide.

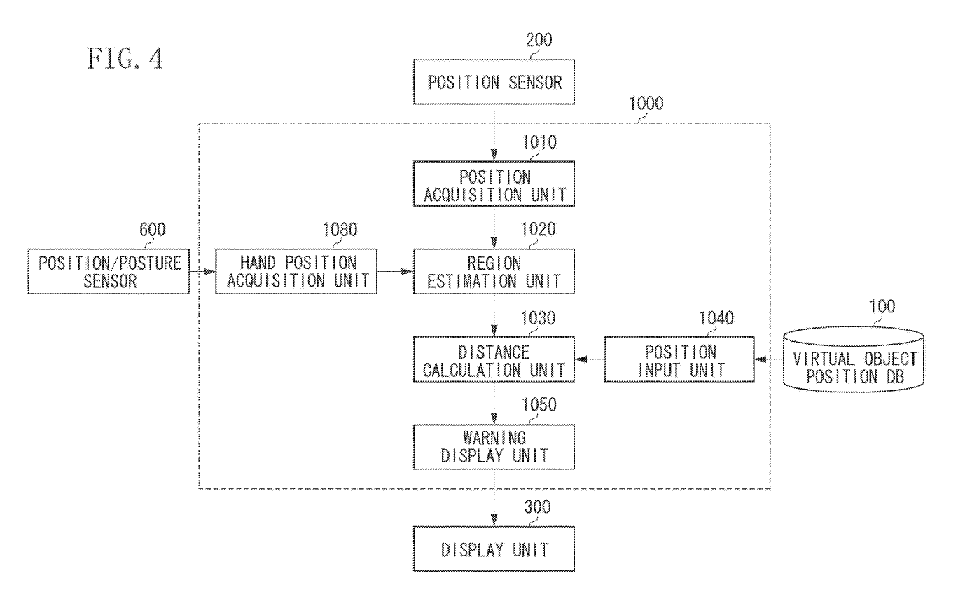

In the first exemplary embodiment, only the position of the display unit 300 is used for the estimation of the region of the display unit wearer. In a third modification of the first exemplary embodiment, as illustrated in FIG. 4, a hand position acquisition unit 1080 for acquiring a hand position of the display unit wearer receives an input from a position/posture sensor 600 worn on the hand of the display unit wearer, and inputs the received data to the region estimation unit 1020.

FIG. 4 is a block diagram illustrating a functional configuration of an information processing apparatus according to the present modification. In the present modification, the system includes the position/posture sensor 600 worn on the hand of the display unit wearer, and the information processing apparatus 1000 includes the hand position acquisition unit 1080 for acquiring the hand position, in addition to the first exemplary embodiment. The position/posture sensor 600, which is worn on the hand of the display unit wearer, outputs the value measured by the position/posture sensor 600 worn on the hand as the position of the hand. A relative positional relationship between the position/posture sensor 600 and the hand of the display unit wearer is calibrated in advance, and the value output from the position/posture sensor 600 is treated as the position of the hand. The position/posture sensor 600 may be a position/posture sensor employing any known method, such as an optical sensor and a magnetic sensor.

In the first exemplary embodiment, the region estimation unit 1020 estimates the region of the display unit wearer as the cylinder. However, the estimation of the region of the display unit wearer is not limited thereto, as long as the region of the display unit wearer can be estimated. The estimated region may be acquired by modifying the cylindrical region estimated in the first exemplary embodiment into an elliptic cylinder, in which a short axis thereof is set to a length from the center of the cylinder to the acquired position of the hand and a long axis thereof is set to a height of the cylinder. This method allows a region defined by adding a region of the hand to the region estimated in the first exemplary embodiment to be set as the region of the display unit wearer.

The present modification allows the information processing apparatus 1000 to warn the display unit wearer about the obstacle with which there is the possibility that the display unit wearer may collide even when the display unit wearer stretches out his/her hand, because the range within arm's reach is contained in the region of the display unit wearer.

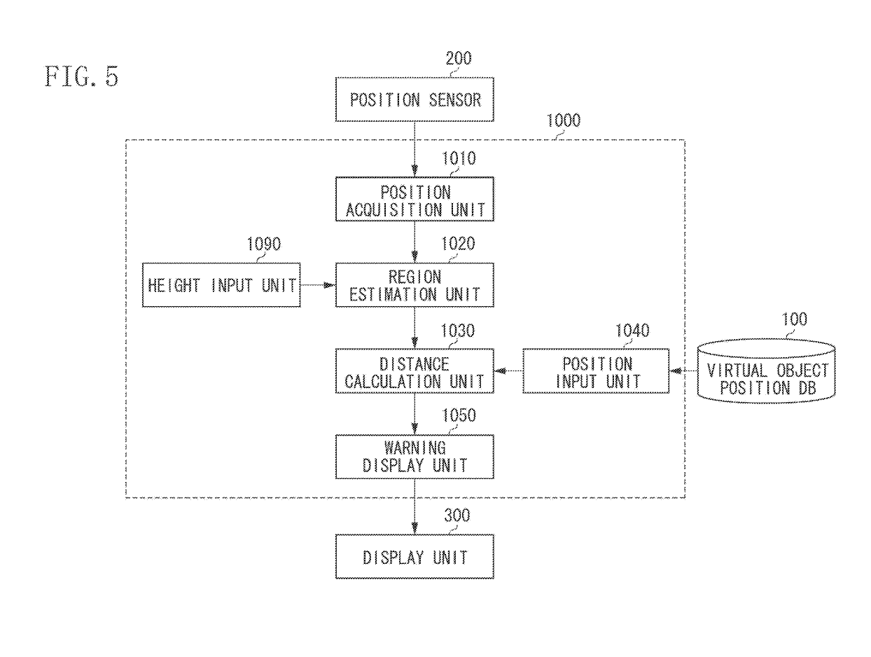

In the first exemplary embodiment, only the position of the display unit 300 is used for the estimation of the region of the display unit wearer. In a fourth modification illustrated in FIG. 5, a height of the display unit wearer is input from a height input unit 1090 for inputting a height of the display unit wearer to the region estimation unit 1020. In this case, the region estimation unit 1020 may set a cylinder having the same height as the input height as the estimated cylindrical region.

In the first exemplary embodiment, the region of the display unit wearer is estimated from the position of the display unit 300. In a fifth modification, a region to be estimated is not limited to the region of the display unit wearer. Region estimation is performed, and a warning is issued to a display unit holder holding the display unit 300. In this case, the predetermined position T1 is determined based on a length of an arm of the holder holding the display unit 300. Further, the predetermined position T2 may be determined based on the height of the display unit holder.

The present modification allows the information processing apparatus 1000 to estimate the region with respect to the display unit holder, thereby allowing the information processing apparatus 1000 to warn the display unit holder about the obstacle with which there is the possibility that the display unit holder may collide, even in a case where the display unit holder holding the display unit 300 experiences the virtual reality.

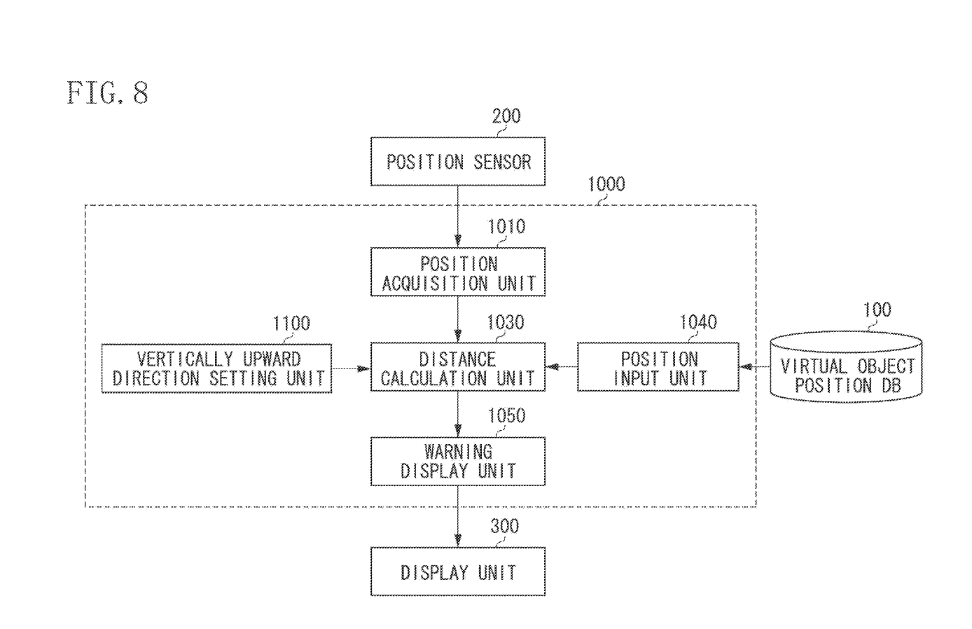

In the first exemplary embodiment, the information processing apparatus 1000 estimates the region where the display unit wearer exists, and calculates the distance between the estimated region and the virtual object. However, in a case where a vertically upward direction is input from a vertically upward direction setting unit 1100 to the distance calculation unit 1030 as illustrated in FIG. 8, the information processing apparatus 1000 does not have to include the region estimation unit 1020, which estimates the region where the display unit wearer exists.

In this case, the position acquisition unit 1010 inputs the position of the display unit 300 to the distance calculation unit 1030. The vertically upward direction setting unit 1100 inputs the vertically upward direction to the distance calculation unit 1030.

The distance calculation unit 1030 calculates a horizontal distance between the display unit wearer and the virtual object based on the input vertically upward direction, the position of the virtual object, and the position of the display unit 300, and inputs the calculated horizontal distance to the warning display unit 1050. The warning display unit 1050 displays the warning on the display unit 300 if the input horizontal distance is equal to a reference distance or less.

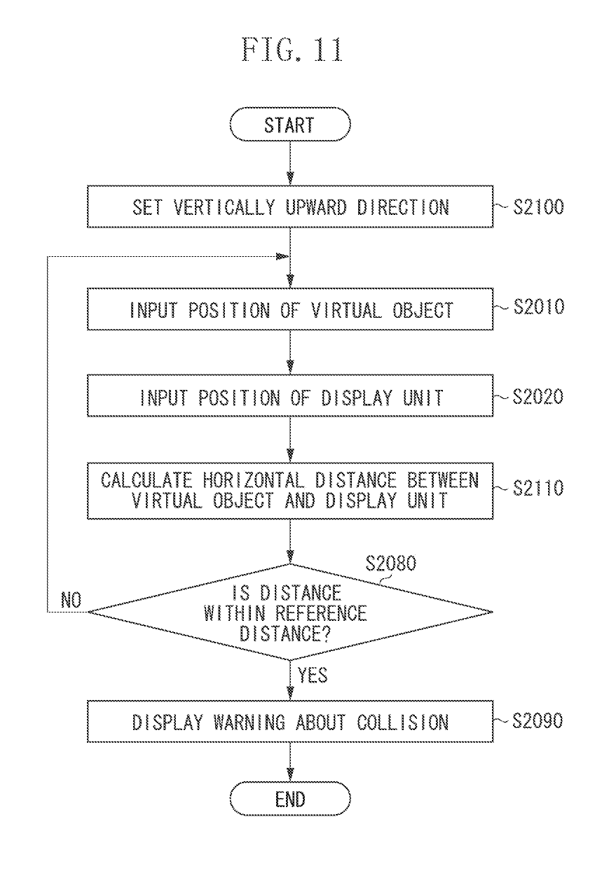

Next, a processing procedure performed by the information processing apparatus 1000 according to a second exemplary embodiment will be described. FIG. 11 is a flowchart illustrating the processing procedure performed by the information processing apparatus 1000 according to the second exemplary embodiment. Steps overlapping the first exemplary embodiment will not be redundantly described below.

In step S2100, the vertically upward direction setting unit 1100 sets the vertically upward direction in the virtual space according to an input from the user. The user selects the vertically upward direction from the coordinate axes in the virtual space while viewing a video image in which a video image of a real space and the coordinate system of the virtual space are superimposed on each other, which is displayed on a graphical user interface (GUI). The vertically upward direction may be input by writing a setting file or may be input by selecting the axis on the screen, as long as the user can set an arbitrary vertically upward direction.

In step S2110, the distance calculation unit 1030 calculates the horizontal distance between the position of the display unit 300 that is input from the position acquisition unit 1010 for acquiring the position of the display unit 300 and the position of the virtual object that is input from the position input unit 1040 for inputting of the position of the virtual object, based on the vertically upward direction input from the vertically upward direction setting unit 1100.

In step S2080, the warning display unit 1050 displays the warning on the display unit 300 if the horizontal distance input from the distance calculation unit 1030 is equal to the reference distance or less.

The present exemplary embodiment prevents the information processing apparatus 1000 from measuring a distance between the display unit wearer and an obstacle above the head or at the foot as a distance longer than an actual distance, thereby allowing the information processing apparatus 1000 to determine the risk of the collision, even when being unable to estimate the region of the display unit wearer.

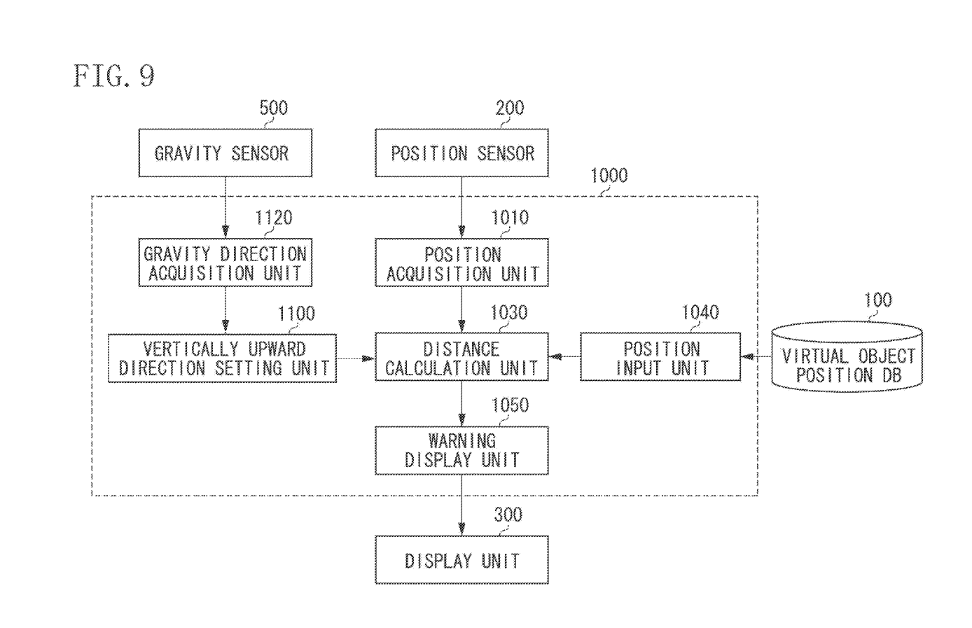

FIG. 9 is a block diagram illustrating a functional configuration of an information processing apparatus 1000 according to a first modification of the second exemplary embodiment. In the present modification, the system includes a gravity sensor 500, and the information processing apparatus 1000 includes a gravity direction acquisition unit 1120, in addition to the second exemplary embodiment.

In the second exemplary embodiment, the vertically upward direction is set by the user. However, in the present modification, the gravity direction acquisition unit 1120 inputs a direction opposite from the direction of gravity input from the gravity sensor 500 to the vertically upward direction setting unit 1100 as the vertically upward direction. The vertically upward direction setting unit 1100 sets the vertically upward direction according to the input from the gravity direction acquisition unit 1120.

The present modification allows the information processing apparatus 1000 to set the vertically upward direction without requiring the user to set the vertically upward direction, and thus prevents the information processing apparatus 1000 from measuring a distance between the display unit wearer and the obstacle above the head or at the foot as a distance longer than the actual distance, thereby succeeding in determining the risk of the collision, even when being unable to estimate the region of the display unit wearer.

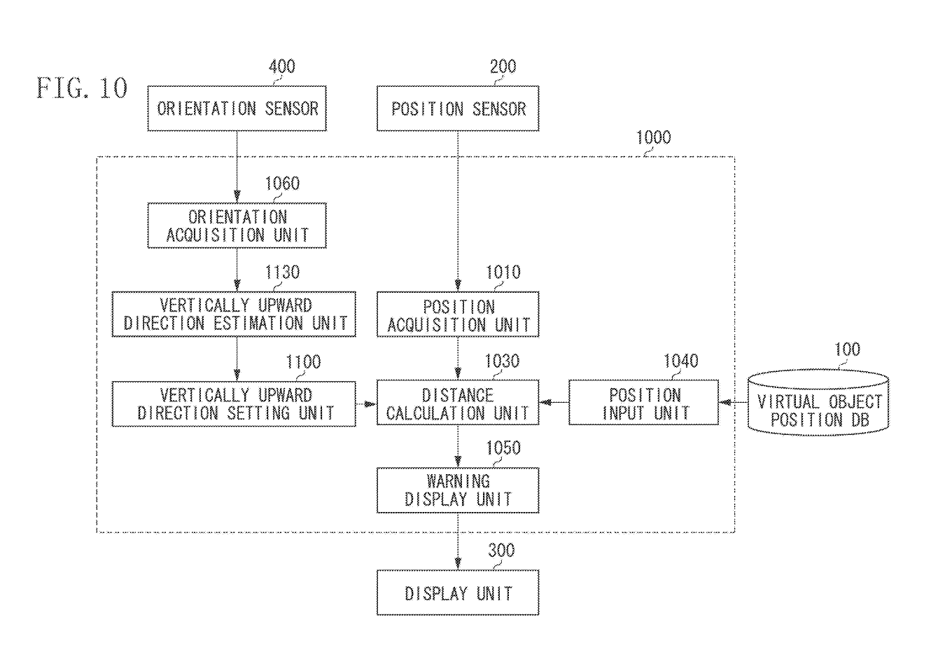

FIG. 10 illustrates a system configuration of a system according to a second modification of the second exemplary embodiment. In the present modification, the system includes the orientation sensor 400 as a sensor for an orientation of the display unit 300, and the information processing apparatus 1000 includes the orientation acquisition unit 1060, for acquiring the orientation of the display unit 300, and a vertically upward direction estimation unit 1130, in addition to the second exemplary embodiment.

In the second exemplary embodiment, the vertically upward direction is set by the user. However, in the present modification, the orientation acquisition unit 1060 for acquiring the orientation of the display unit 300 receives the input from the orientation sensor 400 as a sensor for the orientation of the display unit 300. The vertically upward direction estimation unit 1130 continuously receives the orientation of the display unit 300 from the orientation acquisition unit 1060 for acquiring the orientation of the display unit 300, estimates an upward direction of an average posture of the wearer based on the orientation of the display unit 300 as the vertically upward direction, and inputs the estimated vertically upward direction to the vertically upward direction setting unit 1100.

The present modification allows the information processing apparatus 1000 to set the vertically upward direction without requiring the user to set the vertical direction and without further using a sensor for detecting the force of gravity or an acceleration. Therefore, the information processing apparatus 1000 can be prevented from measuring a distance between the display unit wearer and the obstacle above the head or at the foot as a distance longer than the actual distance, thereby further correctly determining the risk of the collision.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-038041, filed Feb. 29, 2016, which is hereby incorporated by reference herein in its entirety.

What is claimed is:

1. An information processing apparatus comprising:
a position acquisition unit configured to acquire a position of a display device in use by a user;
a region estimation unit configured to estimate a region where the user exists, based on the position of the display device;
an input unit configured to input a position of an object;
a calculation unit configured to calculate a distance between the position of the object and the region; and
a warning unit configured to issue a warning to the user based on the distance.

2. The information processing apparatus according to claim 1, further comprising an orientation acquisition unit configured to acquire an orientation of the display device,
wherein the region estimation unit estimates the region where the user exists, based on the position and the orientation of the display device.

3. The information processing apparatus according to claim 1, further comprising a database storing a relationship between the position of the display device and a posture of the user of the display device,
wherein the region estimation unit estimates the posture of the user by referring to the database based on the position of the display device, and estimates the region where the user exists, based on the posture and the position of the display device.

4. The information processing apparatus according to claim 1, further comprising a second position acquisition unit configured to acquire a position of a hand of the user,
wherein the region estimation unit estimates the region where the user exists based on the position of the display device and the position of the hand of the user.

5. The information processing apparatus according to claim 1, further comprising a height input unit configured to input a height of the user,
wherein the region estimation unit estimates the region where the user exists based on the position of the display device and the height of the user.

6. The information processing apparatus according to claim 1, further comprising a setting unit configured to set a vertically upward direction in a virtual space,
wherein the region estimation unit estimates the region where the user exists based on the position of the display device and the vertically upward direction, and
wherein the calculation unit calculates a horizontal distance between the user and the object.

7. The information processing apparatus according to claim 6, further comprising a measurement unit configured to measure a direction of gravity,
wherein the setting unit sets the vertically upward direction based on the measured direction of gravity.

8. The information processing apparatus according to claim 6, further comprising:
an orientation acquisition unit configured to acquire an orientation of the display device; and
a direction estimation unit configured to estimate the vertically upward direction based on the orientation of the display device,
wherein the setting unit sets the estimated vertically upward direction.

9. The information processing apparatus according to claim 1, wherein the display device is used while being worn on a head portion of the user.

10. The information processing apparatus according to claim 1, wherein the display device is used while being held by a hand of the user.

11. The information processing apparatus according to claim 1, wherein the warning unit displays warning information on the display device.

12. The information processing apparatus according to claim 1, wherein the warning unit issues the warning with use of audio.

13. An information processing method comprising:
acquiring a position of a display device in use by a user;
estimating a region where the user exists, based on the position of the display device;
inputting a position of an object;
calculating a distance between the position of the object and the region; and
issuing a warning to the user based on the distance.

14. The information processing method according to claim 13, further comprising acquiring an orientation of the display device,
wherein the estimating estimates the region where the user exists, based on the position and the orientation of the display device.

15. The information processing method according to claim 13, further comprising storing a relationship between the position of the display device and a posture of the user of the display device,
wherein the estimating estimates the posture of the user by referring to the database based on the position of the display device, and estimates the region where the user exists, based on the posture and the position of the display device.

16. The information processing method according to claim 13, further comprising acquiring a position of a hand of the user,
wherein the estimating estimates the region where the user exists based on the position of the display device and the position of the hand of the user.

17. A non-transitory computer-readable storage medium storing a program for causing a computer to function as:
a position acquisition unit configured to acquire a position of a display device in use by a user;
a region estimation unit configured to estimate a region where the user exists, based on the position of the display device;
an input unit configured to input a position of an object;
a calculation unit configured to calculate a distance between the position of the object and the region; and
a warning unit configured to issue a warning to the user based on the distance.

18. The non-transitory computer-readable storage medium according to claim 17, the program further causing the computer to function as an orientation acquisition unit configured to acquire an orientation of the display device,
wherein the region estimation unit estimates the region where the user exists, based on the position and the orientation of the display device.

19. The non-transitory computer-readable storage medium according to claim 17, the program further causing the computer to function as a database storing a relationship between the position of the display device and a posture of the user of the display device,
wherein the region estimation unit estimates the posture of the user by referring to the database based on the position of the display device, and estimates the region where the user exists, based on the posture and the position of the display device.

20. The non-transitory computer-readable storage medium according to claim 17, the program further causing the computer to function as a second position acquisition unit configured to acquire a position of a hand of the user,
wherein the region estimation unit estimates the region where the user exists based on the position of the display device and the position of the hand of the user.
